(19) United States
(12) Patent Application Publication
(10) Pub. No.: US 2018/0284516 A1
(43) Pub. Date: Oct. 4, 2018

(54) DISPLAY DEVICE

(71) Applicant: Japan Display inc., Minato-ku (JP)

(72) Inventor: Masahiro KOBAYASHI, Tokyo (JP)

(73) Assignee: Japan Display Inc., Minato-ku (JP)

(21) Appl. No.: 15/941,039

(22) Filed: Mar. 30, 2018

(30) Foreign Application Priority Data
Mar. 31, 2017 (JP) 2017-071635

(51) Int. Cl. G02F 1/1339; G02F 1/1362; G02F 1/1333

(52) U.S. Cl. CPC G02F 1/13394; G02F 1/136286; G02F 1/133345; G02F 1/1345; G02F 2201/123; G02F 2201/121; G02F 2001/13396

(57) ABSTRACT

According to one embodiment, display device includes a first substrate provided with pixels including pixel electrodes, respectively, a second substrate opposed to the first substrate, a liquid crystal layer enclosed between the first substrate and the second substrate, a first spacer and a second spacer on an inner surface of the second substrate opposed to the first substrate, the second spacer differing in height from the first spacer, first array pillars on the first substrate, opposed to the first spacer and the second spacer, respectively, and second array pillars on the first substrate, differing in height from the first array pillars, respectively.

### CROSS-REFERENCE TO RELATED APPLICATIONS

This application is based upon and claims the benefit of priority from Japanese Patent Application No. 2017-071635, filed Mar. 31, 2017, the entire contents of which are incorporated herein by reference.

### FIELD

Embodiments described herein relate generally to a display device.

### BACKGROUND

As a display device, for example, a liquid crystal display device comprises a first substrate (array substrate) on which pixel electrodes, thin-film transistors (TFTs), etc., are provided in a matrix, a second substrate (counter-substrate) opposed to the first substrate, and a liquid crystal layer held between the first substrate and the second substrate. The first substrate and the second substrate are attached to each other by a sealing member, and the liquid crystal layer is enclosed inside the sealing member. In addition, to maintain a gap between the first substrate and the second substrate, spacers are provided between the substrates. As the spacers, spacers in a crossed-pillar arrangement in which spacers on the first substrate and spacers on the counter-substrate are arranged to intersect each other have been proposed.

In recent years, as the liquid crystal display device becomes thinner, the gap between the first substrate and the second substrate becomes smaller. At the same time, as the transmittance of the liquid crystal display device becomes greater, the width of a black matrix becomes smaller. In general, the spacers are provided at positions opposed to the black matrix. If such a thin liquid crystal display device having high transmittance is bent or crushed, the array substrate and the counter-substrate are displaced, so that the spacers may rub an array of pixels. As a result, liquid crystal alignment is disordered, and bright spots (PS marks) can occur. The occurrence of bright spots affects the display quality of the liquid crystal display device badly. In addition, if the width of the black matrix is increased to suppress the occurrence of bright spots, the transmittance of the liquid crystal display device decreases.

### BRIEF DESCRIPTION OF THE DRAWINGS

FIG. 1 is a perspective view schematically showing a liquid crystal display device according to a first embodiment.

FIG. 2 is a plan view schematically showing pixels on an array substrate of the liquid crystal display device.

FIG. 3 is a plan view schematically showing the pixels on the array substrate of the liquid crystal display device and a light-shielding layer (black matrix) in an overlapping manner.

FIG. 4 is a sectional view of the liquid crystal display device along line A1-A1 of FIG. 3.

FIG. 5 is a perspective view schematically showing a crossed arrangement of a spacer provided on a counter-substrate and an array pillar provided on the array substrate.

FIG. 6A is a plan view schematically showing the pixels, a main spacer, a first array pillar, and second array pillars.

FIG. 6B is a diagram schematically showing a positional relationship between the main spacer and the array pillars in a normal state.

FIG. 6C is a diagram schematically showing the positional relationship between the main spacer and the array pillars in a case where a liquid crystal panel is crushed.

FIG. 6D is a diagram schematically showing the positional relationship between the main spacer and the array pillars in a case where the liquid crystal panel is bent.

FIG. 7 is a sectional view showing a state in which a liquid crystal display device according to a second embodiment is broken in a plane including a main spacer and a sub-spacer.

FIG. 8 is a plan view schematically showing pixels on an array substrate of a liquid crystal display device according to a third embodiment.

FIG. 9 is a plan view schematically showing the pixels on the array substrate of the liquid crystal display device according to the third embodiment and a light-shielding layer (black matrix) in an overlapping manner.

FIG. 10 is a sectional view of the liquid crystal display device along line A2-A2 of FIG. 9.

FIG. 11A is a plan view schematically showing the pixels, a main spacer, a first array pillar, and second array pillars.

FIG. 11B is a diagram schematically showing a positional relationship between the main spacer and array pillars in a normal state.

FIG. 11C is a diagram schematically showing the positional relationship between the main spacer and the array pillars in a case where a liquid crystal panel is crushed.

FIG. 11D is a diagram schematically showing the positional relationship between the main spacer and the array pillars in a case where the liquid crystal panel is bent.

FIG. 12 is a sectional view showing a state in which a liquid crystal display device according to a fourth embodiment is broken in a plane including a main spacer and a sub-spacer.

### DETAILED DESCRIPTION

Various embodiments will be described hereinafter with reference to the accompanying drawings. In general, according to one embodiment, a display device comprises a first substrate provided with pixels including pixel electrodes, respectively; a second substrate opposed to the first substrate; a liquid crystal layer enclosed between the first substrate and the second substrate; a first spacer and a second spacer on an inner surface of the second substrate opposed to the first substrate, the second spacer differing in height from the first spacer; first array pillars on the first substrate, opposed to the first spacer and the second spacer, respectively; and second array pillars on the first substrate, differing in height from the first array pillars, respectively.

The disclosure is merely an example, and proper changes in keeping with the spirit of the invention, which are easily conceivable by a person with ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

In the embodiments, a liquid crystal display device is disclosed as an example of a display device. The liquid crystal display device may be used for various devices, for example, a wearable device such as a watch or a navigation system, a smartphone, a tablet, a mobile phone, a personal computer, a television receiver, in-vehicle equipment and a game console.

### First Embodiment

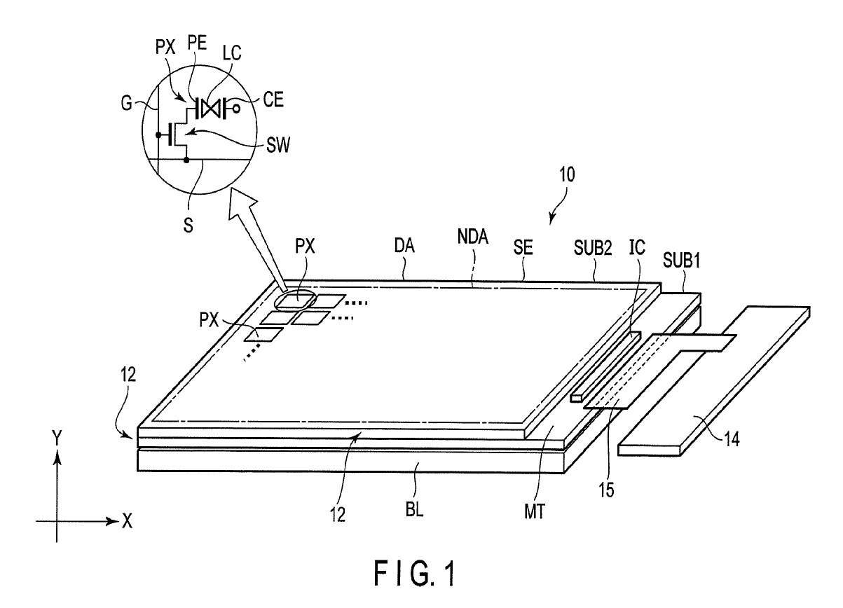

FIG. 1 is a perspective view showing a liquid crystal display device according to a first embodiment.

The liquid crystal display device 10 comprises an active-matrix liquid crystal display panel 12, a driver IC chip CP which drives the liquid crystal display panel 12, a control module 14, a flexible printed circuit (FPC) 15, etc. Moreover, the liquid crystal display device 10 comprises an illumination device (backlight device) BL opposed to the back surface of the liquid crystal display panel 12.

The liquid crystal display panel 12 comprises an array substrate (first substrate) SUB1 having the shape of a rectangular flat plate, a counter-substrate (second substrate) SUB2 opposed to the array substrate SUB1 and having the shape of a rectangular flat plate, and a liquid crystal layer LC held between the array substrate SUB1 and the counter-substrate SUB2. The array substrate SUB1 and the counter-substrate SUB2 are formed of, for example, an insulating substrate such as a glass plate or a transparent resin substrate. The array substrate SUB1 and the counter-substrate SUB2 are attached to each other by a sealing member SE in the shape of a frame with a predetermined cell gap formed therebetween. The liquid crystal layer LC is held in an inside area surrounded by the sealing member SE in the cell gap. The liquid crystal display panel 12 comprises a display area (active area) DA where an image is displayed and a non-display area (frame area) NDA in the shape of a frame located around the display area DA in the inside area surrounded by the sealing member SE. The display area DA is formed of pixels PX arranged in a matrix. The display area DA is formed into the shape of a square in the shown example, but may be formed into the shapes of other polygons, or other shapes such as a circular shape and an elliptic shape.

The array substrate SUB1 comprises a scanning line (gate line) G, a signal line S, a switching element SW, a pixel electrode PE, a common electrode CE, etc., in the display area DA. The scanning line G extends, for example, along a first direction X. The signal line S extends along a second direction Y intersecting the first direction X. In the shown example, the first direction X and the second direction Y are orthogonal to each other. The scanning line G may not be formed into the shape of a straight line parallel to the first direction X, and the signal line S may not be formed into the shape of a straight line parallel to the second direction Y. For example, the scanning line G and the signal line S may be curved or may be partly branched.

The switching element SW is electrically connected to the scanning line G and the signal line S in each of the pixels PX. The pixel electrode PE is electrically connected to the switching element SW in each of the pixels PX. The common electrode CE is provided to be common to the pixels PX, and is set to a common potential.

Signal supply sources necessary to drive the liquid crystal display panel 12, such as the driver IC chip CP and the FPC 15, are provided in the non-display area NDA outside the display area DA. In the shown example, the array substrate SUB1 comprises a mounting portion MT which extends to be outside one side edge of the counter-substrate SUB2. The driver IC chip CP and the FPC 15 are mounted on the mounting portion MT. The FPC 15 extends outward from the array substrate SUB1, and its extending end is connected to the control module 14.

The liquid crystal display panel 12 is, for example, a transmissive display panel having a transmissive display function of displaying an image by selectively transmitting light from the backlight device BL, but is not limited to this. For example, the liquid crystal display panel 12 may be a reflective display panel having a reflective display function of displaying an image by selectively reflecting light from the display surface side, such as external light and auxiliary light from a front light unit. The liquid crystal display panel 12 may be a transflective display panel having the transmissive display function and the reflective display function.

In the liquid crystal display panel 12, in a display mode using a lateral electric field along an X-Y plane defined by the first direction X and the second direction Y or the substrate main surface, both the pixel electrode PE and the common electrode CE are provided on the array substrate SUB1. In addition, in a display mode using a longitudinal electric field along the normal of the X-Y plane or a display mode using an inclined electric field inclined obliquely with respect to the X-Y plane, the pixel electrode PE is provided on the array substrate SUB1, whereas the common electrode CE is provided on the counter-substrate SUB2. Furthermore, the liquid crystal display panel 12 may be configured to conform to a display mode using the above longitudinal electric field, lateral electric field and inclined electric field in combination as appropriate.

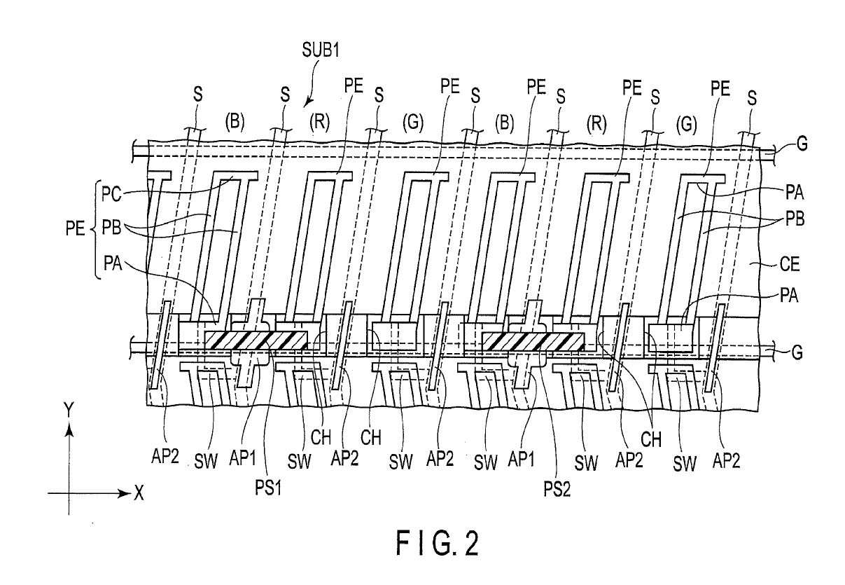

FIG. 2 is a plan view schematically showing a structural example of pixels on the array substrate SUB1 and spacers provided on the counter-substrate side. A structural example of the liquid crystal display panel 12 to which the display mode using a lateral electric field is applied as an example of the display modes will be herein explained. The figure shows only the main portions necessary for explanation.

The array substrate SUB1 comprises scanning lines (gate lines) G, signal lines S, switching elements, for example, thin-film transistors (TFTs) SW, pixel electrodes PE, a common electrode CE, etc.

The scanning lines G each extend along the first direction X, and are arranged at regular pitches in the second direction Y. The signal lines S each extend substantially along the second direction Y, and are arranged at regular pitches in the first direction X. In the shown example, the signal lines S extend in a direction inclined at an acute angle with respect to the second direction Y. The scanning lines G and the signal lines S intersect each other in the X-Y plane. Each of the switching elements SW is provided near the intersection of the scanning line G and the signal line S, and electrically connected to the scanning line G and the signal line S.

The common electrode CE extends over substantially all the area of the array substrate SUB1. That is, in the X-Y plane, the common electrode CE overlaps the scanning lines G, the signal lines S, and the switching elements SW, and extends in the X and Y directions. The common electrode CE is provided on the array substrate SUB1 with an insulating film such as a planarizing film not shown in the figures interposed therebetween. The common electrode CE is formed of a transparent conductive coating, for example, indium tin oxide (ITO).

The pixel electrodes PE are provided to overlap the common electrode CE with an insulating layer not shown in the figures interposed therebetween. The pixel electrodes PE are each provided in an area surrounded by two scanning lines G and two signal lines S, and are arranged at intervals in the first direction X. The pixel electrodes PE are electrically connected to the switching elements SW. The pixel electrodes PE each comprise a plurality of, for example, two, electrode portions PB extending substantially parallel with a gap therebetween, a connecting portion PC connecting end portions of the electrode portions PB, and a contact portion PA connecting the other end portions of the electrode portions PB. The two electrode portions PB extend substantially parallel to the signal lines S. The electrode portions PB may also be referred to as strip electrodes, linear electrodes, comb electrodes, etc. The contact portion PA is located to be adjacent to one of the scanning lines G, and electrically connected to the switching element SW via a contact hole CH formed in the common electrode CE and the insulating film. The pixel electrodes PE are formed of a transparent conductive coating, for example, ITO.

The shape of the pixel electrodes PE is not limited to the shown example. For example, the connecting portion PC may be omitted and the number of electrode portions PB may not be two.

The pixels having the above-described structure are combined with color filters CF, which will be described later, thereby forming a red pixel R, a green pixel G, and a blue pixel B arranged in order in the first direction X. These pixels are not limited to three colors, and may further include a white pixel.

First array pillars AP1 and second array pillars AP2 are provided to stand at positions in the array substrate SUB1. Each of the first array pillars AP1 is provided at a position overlapping the intersection of the signal line S and the scanning line G and in the vicinity of the switching element SW between the red pixel R and the blue pixel B. The first array pillars AP1 have a predetermined length along an extending direction of the signal lines S, and are arranged to overlap the signal lines S. In addition, the central portions of the first array pillars AP1 are formed wide, and extend in the X direction.

The second array pillars AP2 are each provided between two first array pillars AP1 adjacent to each other in the X direction. The second array pillars AP2 are arranged at predetermined pitches in the X direction with the first array pillars AP1. In the present embodiment, two second array pillars AP2 are provided between two first array pillars AP1. Each of the second array pillars AP2 is provided at a position overlapping the intersection of the signal line S and the scanning line G and in the vicinity of the switching element SW. The second array pillars AP2 have a predetermined length along the extending direction of the signal lines S, and arranged to overlap the signal lines S. The second array pillars AP2 have a predetermined width. It is preferable that the width of the second array pillars AP2 be less than or equal to the width of the signal lines S.

As will be described later, the first array pillars AP1 and the second array pillars AP2 differ in height from each other. In the present embodiment, the first array pillars AP1 are formed high, and the second array pillars AP2 are formed low.

FIG. 2 shows spacers provided on the counter-substrate SUB2 side. As will be described later, the spacers include a first spacer (main spacer) PS1 which maintains a cell gap between the array substrate SUB1 and the counter-substrate SUB2 and a second spacer (sub-spacer) PS2 which supports the maintenance of the cell gap when the liquid crystal display panel 12 is crushed or bent. For example, the first spacer PS1 and the second spacer PS2 are provided at positions opposed to the first array pillars AP1 on the array substrate SUB1, respectively.

That is, the first spacer PS1 is provided at a position overlapping the intersection of the signal line S and the scanning line G and in the vicinity of the switching element SW between the red pixel R and the blue pixel B. The first spacer PS1 has a predetermined length along an extending direction (X direction) of the scanning line G, and is opposed to the scanning line G. The first spacer PS1 extends in a direction intersecting the first array pillar AP1, and its central portion in the longitudinal direction is opposed to the central portion in the longitudinal direction of the first array pillar AP1. The width of the first spacer PS1 is substantially equal to the width of the scanning line G, or slightly greater than the width of the scanning line G.

The second spacer PS2 is provided at a position overlapping the intersection of the signal line S and the scanning line G and in the vicinity of the switching element SW between the red pixel R and the blue pixel B. The second spacer PS2 has a predetermined length along the extending direction (X direction) of the scanning line G, and is opposed to the scanning line G. The second spacer PS2 extends in a direction intersecting the first array pillar AP1, and its central portion in the longitudinal direction is opposed to the central portion in the longitudinal direction of the first array pillar AP1. The width of the second spacer PS2 is substantially equal to the width of the scanning line G or slightly greater than the width of the scanning line G. As will be described later, for example, the second spacer PS2 is formed lower than the first spacer PS1. The second spacer PS2 is thereby opposed to the first array pillar AP1 with a gap therebetween.

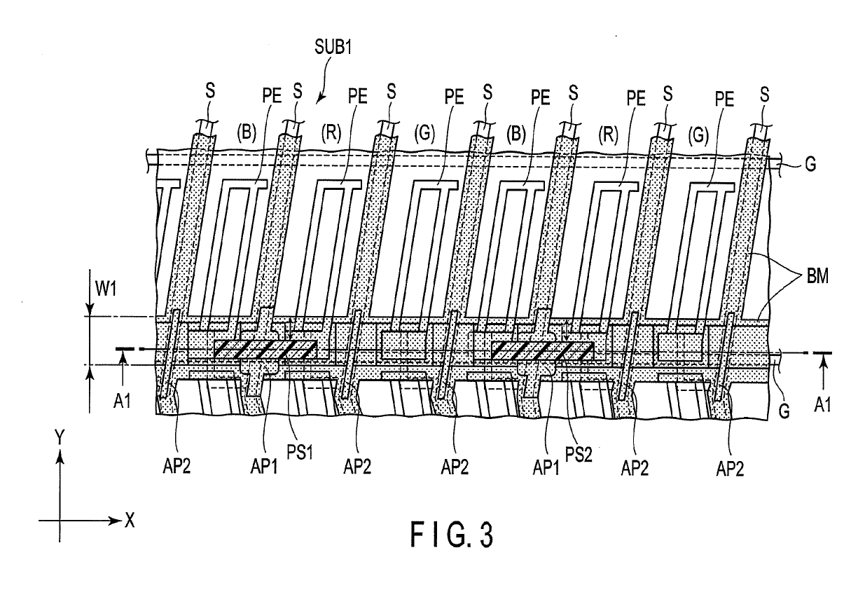

FIG. 3 is a plan view further showing the light-shielding layer (black matrix) BM provided on the counter-substrate side, which overlaps the pixels on the array substrate SUB1 and the spacers provided on the counter-substrate side. As shown in the figure, the light-shielding layer BM provided on the counter-substrate SUB2 is formed in a matrix, and is disposed in an area opposed to wiring portions such as the signal lines S, the scanning lines G, the contact portions PA, and the switching elements SW of the array substrate SUB1. The light-shielding layer BM defines a number of opening portions. The respective opening portions correspond to areas opposed to the pixel electrodes PE. In the light-shielding layer BM, an X-direction-extending area extending in the X direction and opposed to the scanning line G is formed to have a width greater than the widths of the first and second spacers PS1 and PS2. In addition, the X-direction-extending area of the light-shielding layer BM is opposed to the first and second spacers PS1 and PS2 and the first and second array pillars AP1 and AP2.

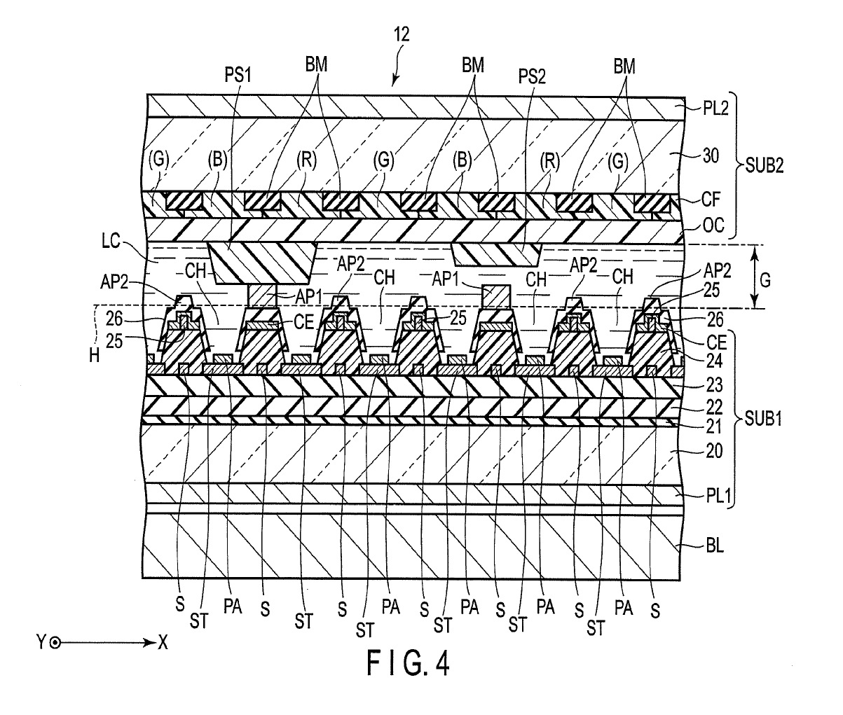

FIG. 4 is a sectional view showing a structural example of the liquid crystal display device along line A1-A1 of FIG. 3. Here, only the main portions necessary for explanation are shown. In the following description, a direction from the array substrate SUB1 to the counter-substrate SUB2 is referred to as “above” or simply “on”.

The array substrate SUB1 is formed, using an insulating substrate 20 having a light transmitting property such as a glass substrate or a resin substrate. The insulating substrate 20 comprises an inner surface opposed to the counter-substrate SUB2 and an outer surface on the opposite side. The array substrate SUB1 comprises an undercoat layer (first insulating film) 21, a gate insulating film (second insulating film) 22, an interlayer insulating film (third insulating film) 23, a planarizing film (fourth insulating film) 24, a fifth insulating film 26, the signal lines S, the scanning lines G, the switching elements SW, the pixel electrodes PE, the common electrode CE, the first and second array pillars AP1 and AP2, an alignment film not shown in the figures, etc., which are provided on the inner surface of the insulating substrate 20. In addition, the array substrate SUB1 comprises a first polarizer PL1, which is provided on the outer surface of the insulating substrate 20.

The undercoat layer 21 is formed on a surface on the counter-substrate SUB2 side of the insulating substrate 20, and covers all of the surface. On the undercoat layer 21, a semiconductor layer not shown in the figure, which forms the switching elements SW, is formed. The gate insulating film 22 is provided to overlap the undercoat layer 21 and the semiconductor layer. On the gate insulating film 22, the scanning lines G not shown in the figure are provided. The interlayer insulating film 23 is provided on the gate insulating film 22 and the scanning lines G. The signal lines S are located on the interlayer insulating film 23. In addition, relay electrodes ST, which are electrically connected to the switching elements SW, are provided on the interlayer insulating film 23. The planarizing film 24 is located on the interlayer insulating film 23, and covers the signal lines S and the relay electrodes ST.

Projections 25 for forming the second array pillars AP2 are provided to project from positions in the planarizing film 24. The projections 25 can be formed by, for example, using a photolithographic process in which the planarizing film 24 is half exposed to light through a halftone mask having transmittance varying locally, and the planarizing film 24 is developed.

The common electrode CE is formed on the planarizing film 24 and the projections 25. The fifth insulating film (planarizing film) 26 is provided on the common electrode CE. In this manner, the projections 25 and overlapping portions of the common electrode CE and the fifth insulating film 26, which overlap the projections 25, form the second array pillars AP2. The second array pillars AP2 project to reach a height corresponding to one sixth to one half a cell gap G between the array substrate SUB1 and the counter-substrate SUB2. In the present embodiment, the height of the second array pillars AP2 is approximately one sixth the cell gap G.

The first insulating film 21, the second insulating film 22, the third insulating film 23, and the fifth insulating film 26 described above are formed of, for example, transparent inorganic materials such as silicon oxide or silicon nitride. The fourth insulating film (planarizing film) 24 is formed of a transparent resin material, and has a film thickness greater than the other insulating films formed of inorganic materials.

Contact holes CH are formed in the fifth insulating film 26, the common electrode CE, and the planarizing film 24. The contact holes CH are provided at positions opposed to the relay electrodes ST. The pixel electrodes PE are provided on the fifth insulating film 26, and opposed to the common electrode CE with the fifth insulating film 26 interposed therebetween. The contact portions PA of the respective pixel electrodes PE are connected to the relay electrodes ST with the contact holes CH interposed therebetween.

The first array pillars AP1 are provided on the fifth insulating film 26. The first array pillars AP1 are formed by, for example, forming an insulating film such as a planarizing film on the fifth insulating film 26 and processing the insulating film by a photolithographic process. The first array pillars AP1 are formed higher than the second array pillars AP2 (AP1>AP2). For example, the height of the first array pillars AP1 is approximately one half the cell gap G. In the present embodiment, the height of array pillars refers to a height from a height H of a pixel portion in a direction perpendicular to the array substrate SUB1. The difference in height between the first array pillars AP1 and the second array pillars AP2 can be, for example, 0.5 to 1 μm.

In the X direction, the first array pillar AP1 is provided, for example, for every three pixels. The second array pillar AP2 is provided between two first array pillars AP1 adjacent to each other in the X direction, and provided for each pixel.

A first alignment film not shown in the figure is formed as an uppermost layer of the above-described array substrate SUB1.

As shown in FIG. 4, the counter-substrate SUB2 is formed, using a transparent insulating substrate 30 such as a glass substrate or a resin substrate. The insulating substrate 30 comprises an inner surface opposed to the array substrate SUB1 and an outer surface on the opposite side. The counter-substrate SUB2 comprises the light-shielding layer BM, the color filters CF, an overcoat layer OC, the main spacer PS1, the sub-spacer PS2, etc., which are provided on the inner surface of the insulating substrate 30. Moreover, the counter-substrate SUB2 comprises a second polarizer PL2, which is provided on the outer surface of the insulating substrate 30.

The light-shielding layer BM is provided on the inner surface of the insulating substrate 30. The light-shielding layer BM is formed in a matrix, and disposed to be opposed to the scanning lines G and the signal lines S of the array substrate SUB1. The light-shielding layer BM defines a number of opening portions opposed to the pixel electrodes PE, respectively. The light-shielding layer BM is formed of a black resin material or a light-shielding metal material.

The color filters CF include, for example, blue filters (B), red filters (R), and green filters (G). These filters are formed of resin materials colored in blue, red, and green, respectively. The color filters CF are formed on the inner surface of the insulating substrate 30, and their respective end portions overlap the light-shielding layer BM. The color filters CF are located at the opening portions of the light-shielding layer BM, and opposed to the corresponding pixel electrodes PE, respectively.

The overcoat layer OC covers the color filters CF. The overcoat layer OC is formed of a transparent resin material. The first spacer PS1 and the second spacer PS2 are provided on the overcoat layer OC.

The first spacer PS1 is provided at a position overlapping a boundary between the red filter (R) and the blue filter (B), and opposed to the first array pillar AP1 of the array substrate SUB1. The first spacer PS1 has a predetermined length along the extending direction (X direction) of the scanning line G, and is opposed to the scanning line G. The height of the first spacer PS1 is one sixth to one half the cell gap G. In the present embodiment, the height of a spacer refers to a height from the uppermost layer of the counter-substrate SUB2, for example, the overcoat layer OC, in a direction perpendicular to the insulating substrate 30. For example, the height of the first spacer PS1 is approximately one half the cell gap G. The first spacer PS1 thereby abuts the first array pillar AP1 on the array substrate SUB1 side. The cell gap G of the liquid crystal display panel 12 is held by the first spacer PS1 and the first array pillar AP1.

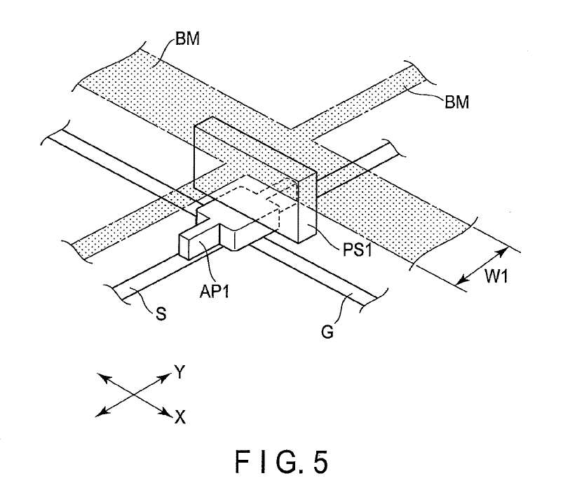

FIG. 5 schematically shows the positional relationship between the first spacer PS1 and the first array pillar AP1. As described above, the first array pillar AP1 extends substantially in the Y direction. On the other hand, the first spacer PS1 extends in a direction intersecting the first array pillar AP1, for example, the X direction, and its central portion in the longitudinal direction is opposed to or abuts the central portion in the longitudinal direction of the first array pillar AP1. The width of the first spacer PS1 is substantially equal to the width of the scanning line G, or slightly greater than the width of the scanning line G. The width W1 of the X-direction-extending area of the light-shielding layer BM opposed to the first spacer PS1 and the first array pillar AP1 is set to a width covering the moving range of the first spacer PS1.

As shown in FIG. 4, the second spacer PS2 is provided at a position overlapping the boundary between the red filter (R) and the blue filter (B), and opposed to the first array pillar AP1 of the array substrate SUB1. The second spacer PS2 has a predetermined length along the extending direction (X direction) of the scanning line G, and is opposed to the scanning line G. The second spacer PS2 is located at a position shifted in the X direction from the first spacer PS1, for example, by three pixels. The height of the second spacer PS2, that is, the height in a direction perpendicular to the insulating substrate 30, is one sixth to one half the cell gap G. In the present embodiment, the height of the second spacer PS2 is less than that of the first spacer PS1, and is, for example, approximately one fourth the cell gap G. The second spacer PS2 is thereby opposed to the first array pillar AP1 on the array substrate SUB1 side with a gap therebetween. The second spacer PS2 abuts the first array pillar AP1 and supports the maintenance of the cell gap G, when the liquid crystal display panel 12 is pressed or bent.

As in the case of the first spacer PS1, the second spacer PS2 extends in a direction intersecting the first array pillar AP1, for example, the X direction, and its central portion in the longitudinal direction is opposed to the central portion in the longitudinal direction of the first array pillar AP1. The width of the second spacer PS2 is substantially equal to the width of the scanning line G or slightly greater than the width of the scanning line G.

The first spacer PS1 and the second spacer PS2 can be formed together, using the same organic polymeric material or resin material. The first spacer PS1 and the second spacer PS2, which differ in height, can be formed together by, for example, using a photolithographic process in which a positive transparent resin material, which is a kind of photosensitive resin material, is applied to the overcoat layer OC, and is then exposed to light through a halftone mask having transmittance varying locally, and the resin material is developed.

In the counter-substrate SUB2, a second alignment film not shown in the figure covers the first and second spacers PS1 and PS2 and the overcoat layer OC. The first alignment film on the array substrate SUB1 side and the second alignment film on the counter-substrate SUB2 side are formed of, for example, a material which exhibits a horizontal alignment property.

As shown in FIG. 4, the array substrate SUB1 and the counter-substrate SUB2 are arranged, such that the first alignment film and the second alignment face each other. The liquid crystal layer LC is enclosed between the first alignment film and the second alignment film. The liquid crystal layer LC is formed of a negative liquid crystal material having negative dielectric anisotropy, or a positive liquid crystal material having positive dielectric anisotropy.

A first polarization axis of the first polarizer PL1 provided on the array substrate SUB1 and a second polarization axis of the second polarizer PL2 provided on the counter-substrate SUB2 have, for example, a crossed-Nicol positional relationship in the X-Y plane.

In the liquid crystal display panel 12 having the above-described structure, the array substrate SUB1 is opposed to the backlight unit BL, and the counter-substrate SUB2 is located on the display surface side. Various types of units are applicable as the backlight unit BL, but description of its detailed structure is omitted.

According to the liquid crystal display device 10 having the above-described structure, the first spacer and the second spacer differing in height and the first array pillars and the second array pillars differing in height are used in combination, whereby the cell gap G can be stably held in any of a normal state, a pressed state and a bent state of the liquid crystal display panel. In addition, in the pressed state or the bent state of the liquid crystal display panel, it is possible to prevent the array pillars or the spacers from contacting or rubbing a pixel array, and to suppress the occurrence of bright spots. That is, the resistance to spacer marks of the liquid crystal display panel can be increased.

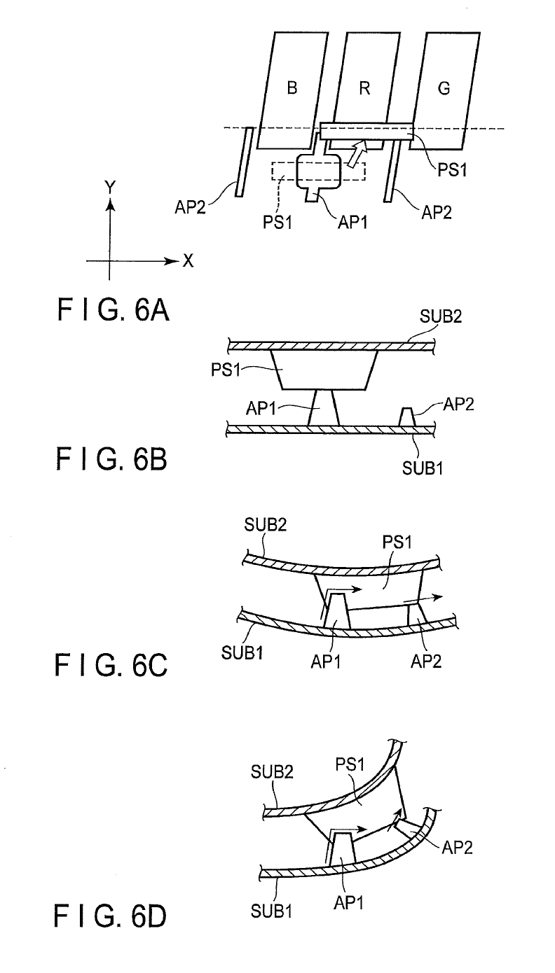

FIG. 6A is a plan view schematically showing the liquid crystal display panel in the normal state. FIG. 6B is a sectional view schematically showing the liquid crystal display panel in the normal state. FIG. 6C is a sectional view schematically showing the liquid crystal display panel in the pressed state (crushed state). FIG. 6D is a sectional view schematically showing the liquid crystal display panel in the bent state.

As indicated by broken lines in FIG. 6A and also as shown in FIG. 6B, in the normal state, the first spacer PS1 abuts the central portion in the longitudinal direction of the first array pillar AP1, and maintains the cell gap G. In addition, the first spacer PS1 is out of contact with the second array pillars AP2 on both sides.

In a state in which the liquid crystal display panel 12 is crushed, as indicated by solid lines in FIG. 6A and also as shown in FIG. 6C, the first spacer PS1, for example, moves in the Y direction, and a part thereof abuts the second array pillar AP2. The first spacer PS1 is thereby supported by the first array pillar AP1 and the second array pillar AP2, and maintains the cell gap G.

In a state in which the liquid crystal display panel 12 is bent, as indicated by solid lines in FIG. 6A and also as shown in FIG. 6D, the first spacer PS1 moves toward a bent portion, for example, in the Y direction, and a part thereof abuts the second array pillar AP2. The first spacer PS1 is thereby supported by the first array pillar AP1 and the second array pillar AP2, and maintains the cell gap G. Moreover, since the panel is bent, the first array pillar AP1 and the second array pillar AP2 are displaced in a direction in which they approach each other. Since the second array pillar AP2 is formed lower than the first array pillar AP1, the array pillars do not contact or collide with each other. Thus, in either case, it is possible to prevent the first and second array pillars or the first and second spacers from contacting or rubbing the pixel array, and to suppress the occurrence of bright spots.

Although not shown in the figures, when the liquid crystal display panel 12 is crushed or bent, the second spacer PS2 abuts the first array pillar AP1, and maintains the cell gap G. In addition, a part of the second spacer PS2 abuts or contacts the second array pillar AP2 and is supported by the second array pillar AP2. Also in this case, the first array pillar AP1 and the second array pillar AP2 do not contact or collide with each other. Thus, it is possible to prevent the first and second array pillars or the first and second spacers from contacting or rubbing the pixel array, and to suppress the occurrence of bright spots.

As described above, the resistance to spacer marks of the liquid crystal display panel is increased, whereby an area where bright spots occur can be greatly reduced. Therefore, the width W1 of the light-shielding layer BM for covering the area where bright spots occur can be reduced, and the light transmittance of the liquid crystal display panel can be improved accordingly.

In view of the above, according to the present embodiment, the liquid crystal display device capable of suppressing the occurrence of bright spots and improving display quality and transmittance can be obtained.

Liquid crystal display devices according to other embodiments will be next described. In the other embodiments which will be described hereinafter, the same portions as those of the above-described first embodiment will be given the same reference numbers, and detailed description thereof will be omitted. Portions differing from those of the first embodiment will be mainly described in detail.

### Second Embodiment

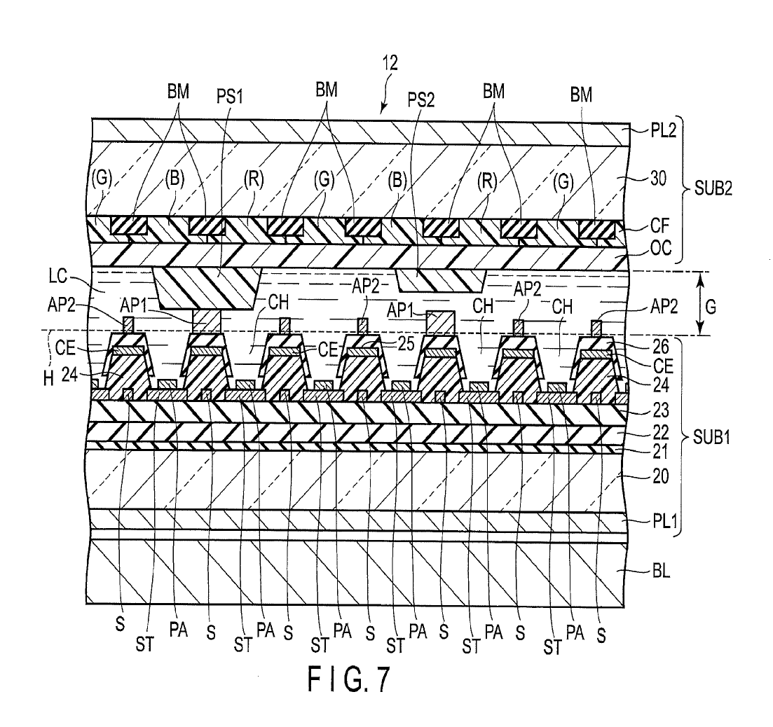

FIG. 7 is a sectional view of a liquid crystal display device according to a second embodiment.

In the second embodiment, the structure of second array pillars AP2 provided on an array substrate SUB1 differs from that in the first embodiment. As shown in FIG. 7, the second array pillars AP2 are provided on a fifth insulating film 26. That is, the second array pillars AP2 are formed by, for example, forming an insulating film such as a planarizing film on the fifth insulating film 26 and processing the insulating film by a photolithographic process.

Similarly, first array pillars AP1 are provided on the fifth insulating film 26. The first array pillars AP1 are formed by, for example, forming an insulating film such as a planarizing film on the fifth insulating film 26 and processing the insulating film by a photolithographic process. The first array pillars AP1 are formed higher than the second array pillars AP2. For example, the height of the first array pillars AP1 is approximately one half a cell gap G. The height of the second array pillars AP2 is approximately one sixth the cell gap G. The difference in height between the first array pillars AP1 and the second array pillars AP2 can be, for example, 0.5 to 1 μm.

The first array pillars AP1 and the second array pillars AP2 may be formed by processing two layers of insulating film separately as described above, or may be formed by processing a common insulating film.

In the second embodiment, the other structures are the same as those in the above-described first embodiment. In addition, also in the second embodiment, the same advantages as those of the above-described first embodiment can be obtained.

### Third Embodiment

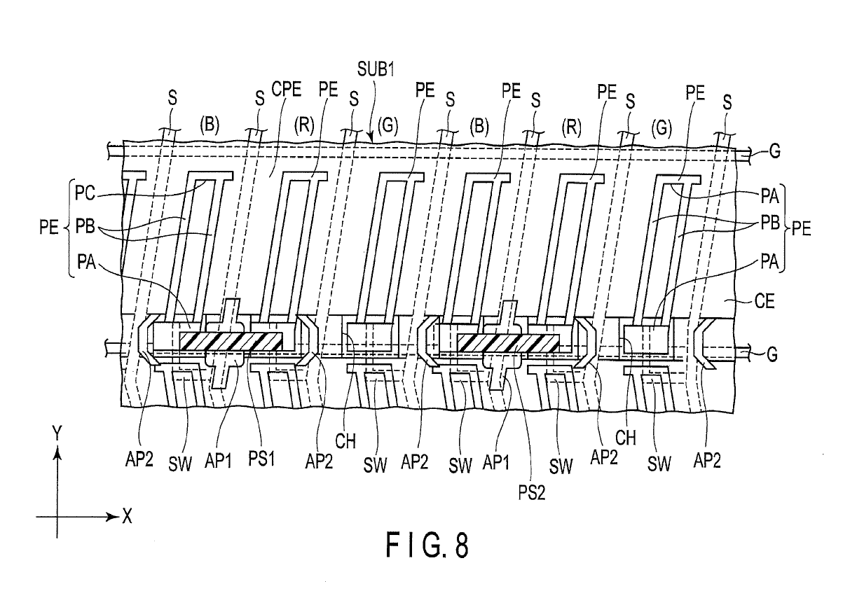

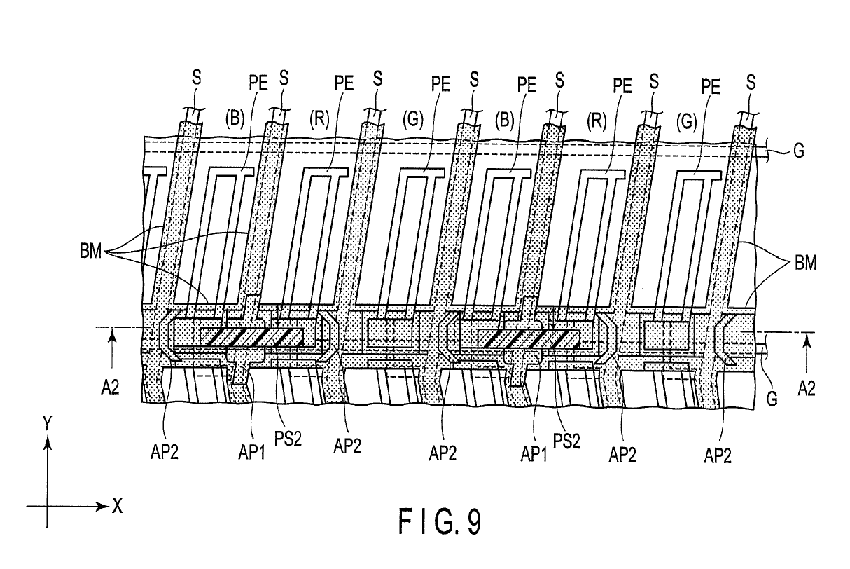

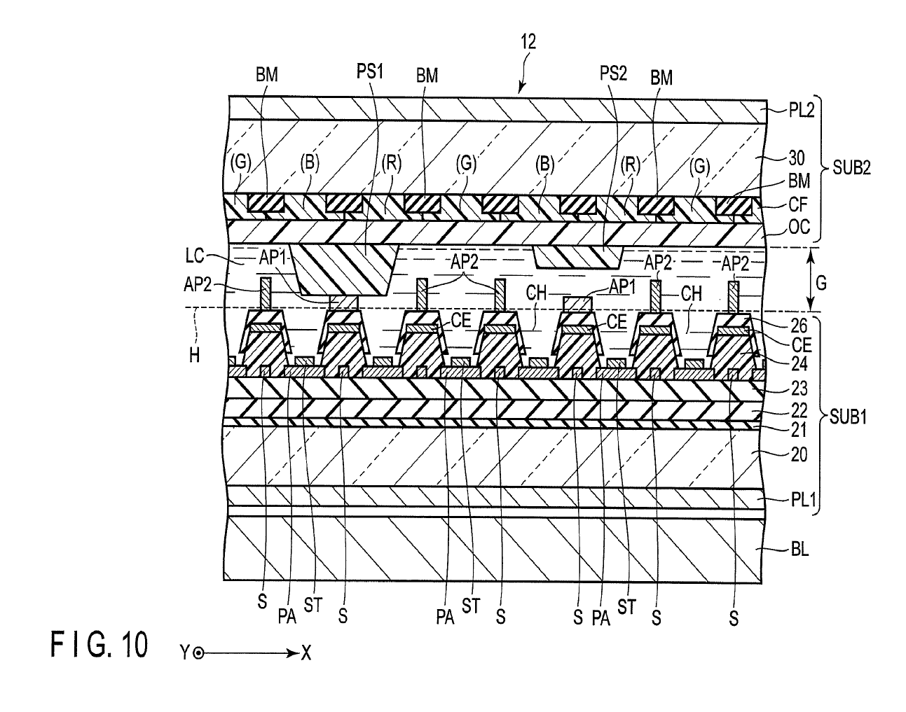

FIG. 8 is a plan view schematically showing pixels on an array substrate of a liquid crystal display device according to a third embodiment. FIG. 9 is a plan view schematically showing the pixels on the array substrate of the liquid crystal display device according to the third embodiment and a light-shielding layer (black matrix) in an overlapping manner. FIG. 10 is a sectional view of the liquid crystal display device along line A2-A2 of FIG. 9.

In the third embodiment, the structure of first array pillars AP1 and second array pillars AP2 provided on the array substrate SUB1 differs from that in the first embodiment. As shown in FIG. 8 and FIG. 9, the second array pillars AP2 are formed into a substantially U shape in plan view (in a state in which the array substrate is viewed in a direction perpendicular to the array substrate SUB1). That is, each of the second array pillars AP2 extends substantially in a Y direction along a signal line S, and both end portions in the longitudinal direction are bent or curved to the first array pillars AP1 side. In an X direction, both end portions in the longitudinal direction of the second array pillars AP2 provided on both sides of each of the first array pillars AP1 are bent or curved to the first array pillars AP1 side. These two second array pillars AP2 on both sides are formed to surround the first array pillar AP1 therebetween.

As shown in FIG. 10, the second array pillars AP2 are provided on a fifth insulating film 26. The second array pillars AP2 are formed by, for example, forming an insulating film such as a planarizing film on the fifth insulating film 26 and processing the insulating film by a photolithographic process. According to the present embodiment, the second array pillars AP2 are formed higher than the first array pillars AP1. For example, the height of the second array pillars AP2 is approximately one half a cell gap G.

The first array pillars AP1 are formed on the fifth insulating film 26. The first array pillars AP1 are formed by, for example, forming an insulating film such as a planarizing film on the fifth insulating film 26 and processing the insulating film by a photolithographic process. The first array pillars AP1 are formed lower than the second array pillars AP2 (AP1<AP2). For example, the height of the first array pillars AP1 is approximately one sixth the cell gap G.

The difference in height between the first array pillars AP1 and the second array pillars AP2 can be, for example, 0.5 to 1 μm.

A first spacer PS1 provided on a counter-substrate SUB2 is formed to have such a height as to abut the first array pillar AP1. A second spacer PS2 is formed lower than the first spacer PS1, and opposed to the first array pillar AP1 with a gap therebetween.

In the third embodiment, the structures other than those described above of the liquid crystal display device are the same as those in the first embodiment.

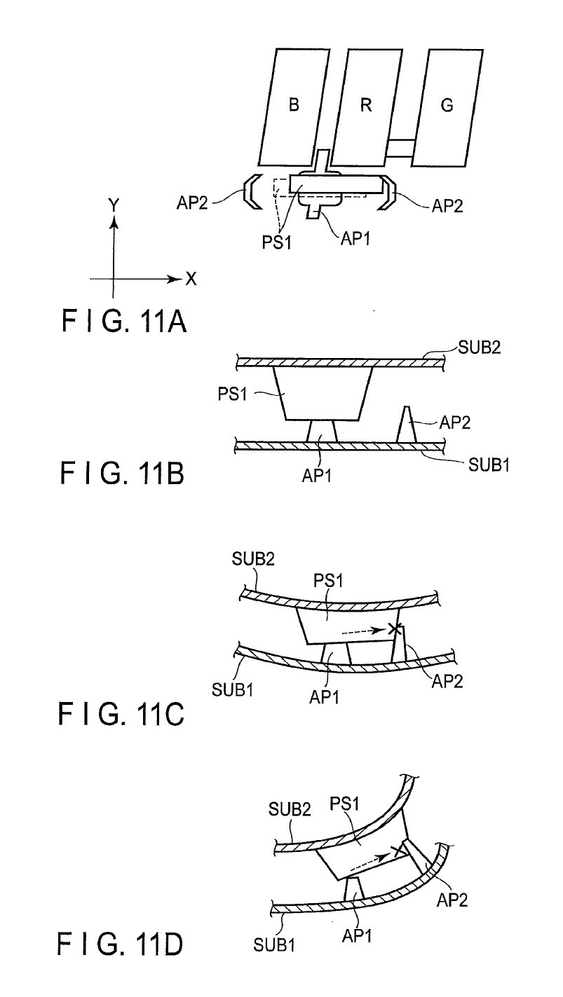

FIG. 11A is a plan view schematically showing a liquid crystal display panel in a normal state. FIG. 11B is a sectional view schematically showing the liquid crystal display panel in the normal state. FIG. 11C is a sectional view schematically showing the liquid crystal display panel in a pressed state (crushed state). FIG. 11D is a sectional view schematically showing the liquid crystal display panel in a bent state.

As indicated by broken lines in FIG. 11A and also as shown in FIG. 11B, in the normal state of the liquid crystal display panel, the first spacer PS1 abuts the central portion in the longitudinal direction of the first array pillar AP1, and maintains the cell gap G. In addition, the first spacer PS1 is out of contact with the second array pillars AP2 on both sides.

In the crushed state of the liquid crystal display panel 12, as indicated by solid lines in FIG. 11A and also as shown in FIG. 11C, the first spacer PS1, for example, slightly moves in the X direction and the Y direction, and its end portion in the movement direction abuts the second array pillar AP2. Most of the first spacer PS1 is kept in a state of abutting the first array pillar AP1, that is, a state of being supported by the first array pillar AP1. The first spacer PS1 is thereby supported by the first array pillar AP1, and maintains the cell gap G. In addition, the second array pillar AP2 functions as a stopper which the first spacer PS1 abuts, and restricts an excess movement or displacement of the first spacer PS1.

In the bent state of the liquid crystal display panel 12, as indicated by solid lines in FIG. 11A and also as shown in FIG. 11D, the first spacer PS1 slightly moves toward a bent portion, for example, in the X direction and the Y direction, and stops when its end portion in the movement direction abuts the second array pillar AP2. That is, the second array pillar AP2 functions as a stopper which the first spacer PS1 abuts, and restricts an excess movement or displacement of the first spacer PS1. Most of the first spacer PS1 is thereby kept in a state of abutting the first array pillar AP1, that is, a state of being supported by the first array pillar AP1. Thus, the first spacer PS1 is supported by the first array pillar AP1 and maintains the cell gap G.

Although not shown in the figures, when the liquid crystal display panel 12 is crushed or bent, the second spacer PS2 abuts the first array pillar AP1, and maintains the cell gap G. In addition, an end portion of the second spacer PS2 abuts the second array pillar AP2. An excess movement or displacement of the second spacer PS2 is thereby restricted, and most of the second spacer PS2 is kept in a state of being supported by the first array pillar AP1.

According to the third embodiment having the above-described structure, even when the liquid crystal display panel is crushed or bent, the second array pillars AP2 can prevent the first spacer and the second spacer from being greatly displaced. Thus, it is possible to prevent the first and second spacers from contacting or rubbing a pixel array, and to suppress the occurrence of bright spots. Therefore, the resistance to spacer marks of the liquid crystal display panel is improved, and the width W1 of the light-shielding layer BM can be reduced accordingly. As a result, the transmittance of the liquid crystal display panel can be improved.

In view of the above, according to the third embodiment, the liquid crystal display device capable of suppressing the occurrence of bright spots and improving display quality and transmittance can be obtained.

### Fourth Embodiment

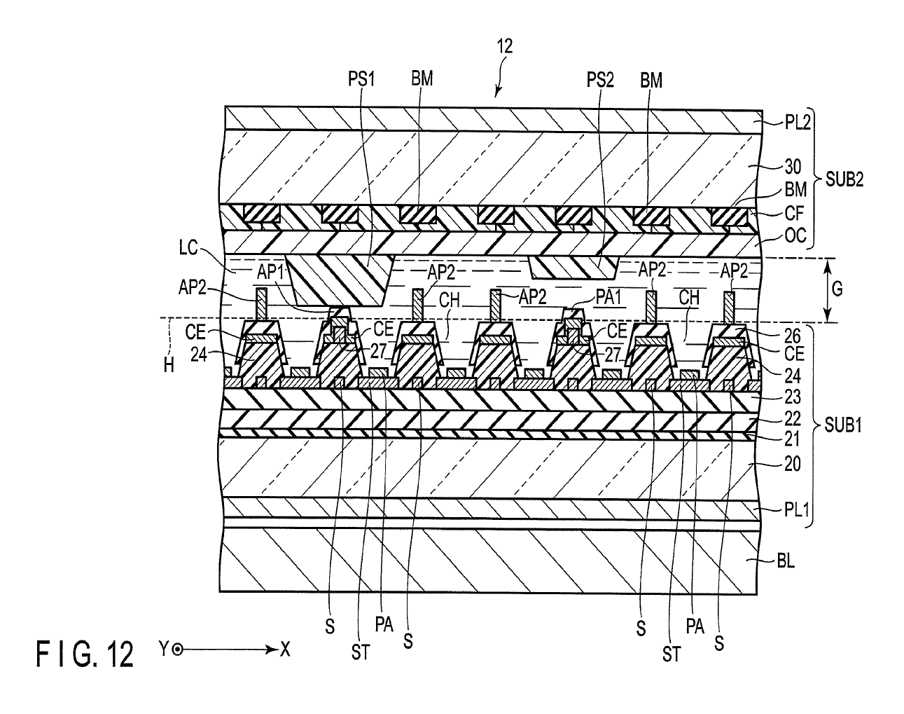

FIG. 12 is a sectional view of a liquid crystal display device according to a fourth embodiment.

In the fourth embodiment, the structure of first array pillars AP1 provided on an array substrate SUB1 differs from that in the third embodiment. As shown in FIG. 12, a planarizing film 24 is located on an interlayer insulating film 23, and covers signal lines S and relay electrodes ST. Projections 27 for forming the first array pillars AP1 are provided to project from positions in the planarizing film 24. The projections 27 can be formed by, for example, using a photolithographic process in which the planarizing film 24 is half exposed to light through a halftone mask having transmittance varying locally, and the planarizing film is developed.

A common electrode CE is formed on the planarizing film 24 and the projections 27. A fifth insulating film (planarizing film) 26 is provided on the common electrode CE. In this manner, the projections 27 and overlapping portions of the common electrode CE and the fifth insulating film 26, which overlap the projections 27, form the first array pillars AP1. The first array pillars AP1 project to reach a height corresponding to one sixth to one half a cell gap G. In the present embodiment, the height of the first array pillars AP1 is approximately one sixth the cell gap G.

Second array pillars AP2 are provided on the fifth insulating film 26. The second array pillars AP2 are formed by, for example, forming an insulating film such as a planarizing film on the fifth insulating film 26 and processing the insulating film by a photolithographic process. The second array pillars AP2 are formed higher than the first array pillars AP1. For example, the height of the second array pillars AP2 is approximately one half the cell gap G. The difference in height between the first array pillars AP1 and the second array pillars AP2 can be, for example, 0.5 to 1 μm.

In the fourth embodiment, the structures other than those described above of the liquid crystal display device are the same as those in the third embodiment. In addition, also in the fourth embodiment, the same advantages as those of the above-described third embodiment can be obtained.

While certain embodiments have been described, these embodiments and modifications have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

All of the structures and manufacturing processes which can be implemented by a person with ordinary skill in the art through arbitrary design changes to the structures and manufacturing processes described above as embodiments of the present invention come within the scope of the present invention as long as they are in keeping with the spirit of the present invention. In addition, other advantages which can be obtained by the above embodiments and are self-evident from the description in this specification or can be arbitrarily conceived by a person with ordinary skill in the art are considered to be achievable by the present invention as a matter of course.

For example, the materials, shapes or dimensions of the structural members are not limited to those described in the above embodiments, and may be selected in various ways.

What is claimed is:

1. A display device comprising:
a first substrate provided with pixels including pixel electrodes, respectively;
a second substrate opposed to the first substrate;
a liquid crystal layer enclosed between the first substrate and the second substrate;
a first spacer and a second spacer on an inner surface of the second substrate opposed to the first substrate, the second spacer differing in height from the first spacer;
first array pillars on the first substrate, opposed to the first spacer and the second spacer, respectively; and
second array pillars on the first substrate, differing in height from the first array pillars, respectively.

2. The display device of claim 1, wherein
the first spacer has a length extending in a first direction,
each of the first array pillars extends in a second direction intersecting the first direction, and
the first spacer abuts one of the first array pillars.

3. The display device of claim 2, wherein
the second spacer extends in the first direction, and is aligned with the first spacer in the first direction, and
the second spacer is formed lower than the first spacer, and opposed to one of the first array pillars with a gap therebetween.

4. The display device of claim 3, wherein
the second array pillars are arranged in the first direction with the first array pillars, and
the second array pillars are formed lower than the first array pillars.

5. The display device of claim 4, wherein
each of the second array pillars extends in the second direction.

6. The display device of claim 3, wherein
the second array pillars are arranged in the first direction with the first array pillars, and
the second array pillars are formed higher than the first array pillars.

7. The display device of claim 6, wherein
each of the second array pillars extends in the second direction.

8. The display device of claim 7, wherein
the second array pillars are disposed on both sides of each of the first array pillars in the first direction, and
each of the second array pillars has both end portions in the second direction, and both the end portions are bent or curved to the first array pillar side.

9. The display device of claim 1, wherein
the first substrate comprises: a first insulating substrate comprising an inner surface opposed to the second substrate; a first insulating film on the inner surface of the first insulating substrate; scanning lines on the first insulating film, each extending in the first direction; a second insulating film on the first insulating film to overlap the scanning lines; signal lines on the second insulating film, extending in a second direction intersecting the first direction; a switching element connected to the signal lines and the scanning lines; a third insulating film on the second insulating film to overlap the signal lines; a common electrode on the third insulating film; and a fourth insulating film on the common electrode, and
the first array pillars are provided on the fourth insulating film.

10. The display device of claim 9, wherein
the second array pillars are formed of projections formed on the third insulating film and overlapping portions of the common electrode and the fourth insulating film, which overlap the projections.

11. The display device of claim 9, wherein
the second array pillars are provided on the fourth insulating film.

12. The display device of claim 1, wherein
the first substrate comprises: a first insulating substrate comprising an inner surface opposed to the second substrate; a first insulating film on the inner surface of the first insulating substrate; scanning lines on the first insulating film, each extending in a first direction; a second insulating film on the first insulating film to overlap the scanning lines; signal lines on the second insulating film, extending in a second direction intersecting the first direction; a switching element connected to the signal lines and the scanning lines; a third insulating film on the second insulating film to overlap the signal lines; a common electrode on the third insulating film; and a fourth insulating film on the common electrode, and
the first array pillars are formed of projections formed on the third insulating film and overlapping portions of the common electrode and the fourth insulating film, which overlap the projections.

13. The display device of claim 12, wherein
the second array pillars are provided on the fourth insulating film.
